(19) United States
(12) Patent Application Publication
(10) Pub. No.: US 2025/0340464 A1
(43) Pub. Date: Nov. 6, 2025

(54) SYSTEM AND METHOD FOR RECOVERY OF PHOSPHATE FROM WASTEWATER AS GRANULAR NATURAL STRUVITE

(71) Applicant: The Research Foundation for the State University of New York, Albany, NY (US)

(72) Inventors: Wendong Tao, Syracuse, NY (US); Aysha Iftikhar, Syracuse, NY (US)

(21) Appl. No.: 19/198,284

(22) Filed: May 5, 2025

Related U.S. Application Data
(60) Provisional application No. 63/642,285, filed on May 3, 2024.

(51) Int. Cl. C02F 1/52; C02F 1/66; C02F 101/10

(52) U.S. Cl. CPC C02F 1/5245; C02F 1/66; C02F 2001/5218; C02F 2101/105; C02F 2209/02

(57) ABSTRACT

A system and method for recovering phosphate from wastewater by dosing mineral products to create struvite crystals, optionally in continuous manner, harvesting the crystals, and converting the crystals into granular natural fertilizers. There is a liquid container having an interior thereof and an outlet therefrom, with the interior configured to receive wastewater in at least a mostly liquid form and the wastewater contains at least phosphate. Added to the wastewater are a calcined magnesite source and a water-soluble magnesium mineral source, and there is a crystal collector under the outlet of the liquid container. There is a post-crystallization granulator or pelletizing machine to transform the harvested struvite crystals. There can be a control system to administer these steps between the components. Air can also be introduced to the mixture to assist in the production of struvite.

### CROSS-REFERENCE TO RELATED APPLICATION

This invention claims the benefit of U.S. Provisional Patent Application No. 63/642,285, filed May 3, 2024, the entirety of which is hereby incorporated herein by this reference.

### STATEMENT REGARDING FEDERALLY SPONSORED RESEARCH

This invention was made with government support under grant number 2241633, awarded by the National Science Foundation. The government has certain rights in the invention.

### BACKGROUND OF THE INVENTION

### 1. Field of the Invention

The present invention generally relates to recovering minerals from wastewater. More particularly, the present invention relates to a system and method for recovering phosphate and ammonium from wastewater and converting into granular products for use in agricultural production and commercial applications.

### 2. Description of the Related Art

Recovery of struvite (MgNH₄PO₄·6H₂O) from phosphate-rich wastewater such as source-separated human urine and anaerobic digestate has gained growing interest in research and commercial applications. It aligns well with the principles of sustainable wastewater treatment and circular economy. Phosphate-rich wastewater can include urine, digestate, liquid animal manure, and some other industrial wastewater stream. Struvite forms in equal mole numbers of ammonium (NH₄⁺), magnesium ions (Mg²⁺), and inorganic phosphate (PO₄³⁻, HPO₄²⁻, and H₂PO₄⁻) and is favorable at pH 8.0-9.5. Nevertheless, phosphate-rich wastewaters often have low pH values and a lower magnesium concentration relative to ammonium and phosphate, demanding the use of external alkali and magnesium sources for struvite precipitation as shown in:

Mg²⁺+NH₄⁺+HₙPO₄³⁻ⁿ+6H₂O→MgNH₄PO₄·6H₂O+nH⁺

Commonly, magnesium is supplemented with soluble salts such as MgCl₂ and MgSO₄ and NaOH is added to increase pH, which often account for up to 75% of the operational cost for extant struvite recovery. Seawater and desalination bittern are low-cost alternative sources of magnesium ions, though they are locally available only and increase wastewater ionic strength and concentrations of interfering ions.

Cheaper Mg(OH)₂ and MgO can be used to supplement Mg²⁺ and raise pH for phosphate-rich wastewater, but the optimum dosages for pH increase and Mg²⁺ supplementation are often different, and their solubilities are relatively low. There have been difficulties to find cost-effective sources of magnesium and alkali for struvite recovery from the near-neutral wastewater.

Additionally, magnesium and alkali should be supplemented from a natural or organic source so that the recovered struvite has the potential to be used for certified organic production. Organic production is characterized by prohibiting the use of chemically synthesized fertilizers. Organic producers are certified according to U.S. Department of Agriculture National Organic Program standards through approved certification bodies. For soil fertilization, organic systems rely on the inputs of fertilizers obtained from crushed phosphate rocks and organic sources such as animal manure, compost, poultry droppings, meat/bone/blood meal, biofertilizer, and biosolids.

Commonly, all such organic and natural mineral fertilizers have limited availability, low nutrient rating, and inconsistent nutrient content, and rely on soil microbes for their nutrient mineralization, leading to crop yields from organic farming on average 25% lower than conventional farming. Therefore, there is a high demand for high-grade natural fertilizers to increase the productivity of organic production systems. Natural fertilizer is a substance composed only of natural organic and/or natural inorganic fertilizer materials and natural fillers. When struvite crystals are recovered from wastewater without use of synthetic chemicals, the recovered crystals can be considered natural inorganic fertilizers and are expected to be accepted for certified organic production.

Recovered struvite and precipitated phosphate salts have been approved for use in organic production by their inclusion in annex II of Regulation 2021/1165 (European Commission, 2023). The Permitted Substance List of Canadian Organic Production Standard (Canadian General Standards Board, 2021) permits all sources of magnesium in the manufacturing process of struvite with livestock manure as well as plant and plant byproducts. According to the U.S. National Organic Program standards, however, struvite recovered from wastewater is considered a synthetic fertilizer, thus being prohibited in certified organic production (USEPA, 2023).

Most organic regulations do not allow chemical processing or use of synthetic compounds in the manufacturing processes, but physical and mechanical processing are allowed. Inputs to organic lands should be natural substances or naturally acquired materials. Therefore, natural minerals after physical or mechanical processing offer a prospect to recover struvite from wastewater for organic production.

Minerals such as brucite (Mg(OH)₂·6H₂O), serpentine (Mg₃Si₂O₅(OH)₄), and magnesite (MgCO₃) have been explored for magnesium supplementation and pH elevation. However, acid dissolution required for brucite is not suitable for producing struvite for organic production. The recovery efficiency by addition of milled serpentine has been shown to decrease with increasing PO₄³⁻ concentration greater than 7 mM since Si released from serpentine acted as seeds for secondary struvite crystallization, making it unsuitable for commercial-scale struvite recovery from wastewater with high phosphate concentrations.

Magnesite has magnesium embedded in its crystal lattice, rendering a low solubility in water. However, calcination of magnesite converts it to magnesium oxide (equation below) which is more soluble than ground magnesite. The dissolution of calcined magnesite in water generates hydroxyl ions which increase water pH. Using calcined magnesite for struvite recovery costs less than bittern and chemicals including MgO, MgCl₂, and MgSO₄.

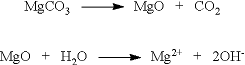

Compared with milled magnesite and milled serpentine Mg₃Si₂O₅(OH)₄, a smaller dosage of calcined magnesite is needed due to its high magnesium content, thus minimizing the residuals left in the wastewater.

Some have evaluated the effects of calcination temperature and duration on the dissolution of calcined magnesite in rare-earth processing wastewater, synthetic phosphate-depleted human urine, acidic electroplating wastewater, and liquid digestate, respectively. However, the calcination process has not been optimized for dissolution of calcined magnesite in real alkaline phosphate-rich wastewater like hydrolyzed urine and air-stripped anaerobic digestate. The dissolution kinetics and capacity of calcined magnesite are determined by reactivity and the concentration gradient around the particles of calcined magnesite in a solvent. The reactivity of calcined magnesite is affected by calcination temperature and residence time.

Mineral-derived water-soluble magnesium salt, for example, the OMRI-listed Magriculture® Epsom salt (MgSO₄·7H₂O crystals), can be directly added for magnesium supplementation. Nevertheless, chemical-free pH elevation is still required for most wastewater streams to precipitate struvite for organic production. Moreover, addition of Epsom salt alone to supplement magnesium increases ionic strength and decreases the activity of struvite ions, which may decrease the effectiveness of struvite formation.

When only calcined magnesite is dosed to reach a Mg²⁺:PO₄³⁻ ratio greater than 1, however, pH may fall outside the optimum range for struvite formation. Vice versa, Mg²⁺:PO₄³⁻ ratio may not be appropriate for efficient phosphate removal when calcined magnesite is dosed to reach the optimum pH range.

Commercial fertilizers are mostly marketed in granulated form. The existing commercial-scale struvite recovery systems produce granular struvite by days of crystal growth inside a reactor. The studies that supplement magnesium with mineral products have not produced a marketable granular fertilizer, neither for conventional nor organic farming. The present invention is to induce struvite precipitation and crystallization with mineral products, harvest fine struvite crystals upon a short crystal residence time, and mechanically turn struvite powder into fertilizer granules with biodegradable organic binding agents.

The present invention therefore provides an advantage in extracting struvite from wastewater for use in agricultural and commercial applications. The present invention is industrially applicable as it produces struvite that can be used as fertilizer, even in organic settings.

### BRIEF SUMMARY OF THE INVENTION

Briefly described, the present system and method utilize the combined use of calcined magnesite and a water-soluble magnesium mineral as an inclusive approach to recovering struvite from various wastewaters for organic production. The invention uses the efficacy of struvite recovery from alkaline hydrolyzed urine as well as from near neutral and slightly alkaline liquor of sludge digestate and animal manure digestate with the addition of both calcined magnesite and Epsom salt. Thus, the invention provides a method of using an organic-certified water-soluble mineral salt alone or a combination of calcined magnesite and the mineral salt to produce struvite. The calcination process is optimized for light-burnt magnesite for struvite recovery from phosphate-rich wastewater and can be upscaled to extract phosphate from a continuous waste stream.

The present invention integrates simple pretreatment by air stripping, mineral-based struvite crystallization, and bio-based granulation in tandem for production of granular natural struvite fertilizers.

In one embodiment, the invention provides a system for recovering phosphate from wastewater with a liquid container having an interior thereof and an outlet therefrom, and the interior configured to receive wastewater in at least a semi-liquid form, where the wastewater containing at least phosphate. There is a filter in the outlet of the liquid container that will remove the struvite. There is a calcined magnesite source and a water-soluble magnesium mineral source to provide these to the wastewater.

There is a control system configured to selectively add the calcined magnesite source to wastewater, then selectively add the water-soluble magnesium mineral source to the wastewater until a predetermined molar ratio of magnesium to phosphate thereby creating a mixture of the calcined magnesite source, water-soluble magnesium mineral source, and wastewater. This process ultimately forms struvite in the mixture and the struvite is collectable in the outlet of the liquid container and can be externally pressed into granules to be used as a granular natural fertilizer.

The system can also include an air source connected to the interior of an air-lift crystallizer and operably connected to the control system such that the control system further selectively controlling a predetermined pressure and flow rate of the air supplied into the crystallizer.

Additionally, the system can further contain one mixer to make the calcined magnesite source into slurry prior to dosing it into the liquid container. The calcined magnesite source, water-soluble magnesium mineral source, and wastewater can all be held inside the container, or can be continuously flowed through the container as a mixture with the filter further configured to continuously remove struvite from the flowing mixture.

Following the liquid container that produces struvite crystals, the system can contain a post-crystallization granulator to quickly convert the crystals into granular struvite fertilizers. At the ratio of 10 grams of struvite crystals to 0.8 grams of organic binder to 5.4 grams of water, the purity of the struvite granules exceed the Association of American Plant Food Control Officials' benchmark for a marketable compound fertilizer. Furthermore, the struvite granules have a great potential to be listed as a crop fertilizer for certified organic production when National Organic Program allowed organic polymers are used as binding agents.

In an embodiment, the invention can also provide a method for recovering phosphate from wastewater by the steps of streaming wastewater through a liquid container having an interior thereof and an outlet therefrom, with the wastewater in at least a semi-liquid form and containing at least phosphate, then adding a calcined magnesite source to the wastewater adding a water-soluble magnesium mineral source to the wastewater until a predetermined molar ratio of magnesium to phosphate thereby creating a mixture of the calcined magnesite source, water-soluble magnesium mineral source. The method continues by forming struvite in the mixture and filtering the struvite from the mixture.

Simple air stripping of CO₂ and sedimentation as quick pretreatment is applied to raise pH and subsequently remove Mg-competing cations so as to increase downstream struvite product purity.

The present invention therefore provides an advantage in obtaining phosphates from wastewater that would otherwise be pollutive and require special disposal. The struvite produced herein can be used as natural fertilizer for traditional farming and organic production. The present invention is also industrially applicable as it can produce commercially viable organic-certifiable fertilizer from a wastewater stream. Other objects, advantages, and features will become apparent to one of skill in the art from review of the present application.

### BRIEF DESCRIPTION OF THE DRAWINGS

FIG. 1 is a schematic diagram of a cross-section of an air-lift crystallizer.

FIG. 2 is a graph of the weight loss of magnesite in response to calcination duration and temperature.

FIG. 3A is a SEM micrograph and graph of EDS spectra of GM-ground magnesite.

FIG. 3B is a SEM micrograph and graph of EDS spectra of CM1-magnesite calcined at 600° C. for 120 min.

FIG. 3C is a SEM micrograph and graph of EDS spectra of CM2-magnesite calcined at 700° C. for 60 min.

FIG. 3D is a SEM micrograph and graph of EDS spectra of CM3-magnesite calcined at 800° C. for 30 min.

FIG. 3E is a SEM micrograph and graph of EDS spectra of CM4-magnesite calcined at 900° C. for 15 min.

FIG. 3F is a SEM micrograph and graph of EDS spectra CM5-magnesite calcined at 1000° C. for 10 min.

FIG. 4 is a graph characterizing ground magnesite (GM) and the magnesite calcined at 600° C. (CM1), 700° C. (CM2), 800° C. (CM3), 900° C. (CM4), and 1000° C. (CM5) by FTIR spectra.

FIG. 5A is an SEM image of struvite crystals harvested from urine dosed with calcined magnesite (CM3).

FIG. 5B is an SEM image of struvite crystals harvested from urine dosed with Epsom salt.

FIG. 6 is a graph of the PO₄³⁻—P concentration, and pH of urine inside crystallizer over time after dosing calcined magnesite and Epsom salt.

FIG. 7 is a graph of the FTIR spectra of struvite crystals obtained from hydrolyzed urine after dosing calcined magnesite and Epsom salt.

FIG. 8 is a graph of XRD diffractograms of struvite crystals obtained from hydrolyzed urine after dosing calcined magnesite and Epsom salt.

FIG. 9A is a graph of dosing curves of calcined magnesite to raise pH of filtrate and supernatant of sludge digestate.

FIG. 9B is a graph of dosing curve of calcined magnesite to raise pH of filtrate separated from co-digestion influent of sludge and chicken manure.

FIG. 10 is a graph of variations of filtrate pH and concentrations of PO₄³⁻ and Mg²⁺ inside the crystallizer as calcined magnesite and Epsom salt were dosed.

FIG. 11 is a series of SEM images with a graph illustrating the EDS mapping of struvite crystals recovered from the filtrate of sludge digestate.

FIG. 12 is a scanning electron microscopy image of the precipitates from air-stripping and settling pretreatment of the filtrate of sludge digestate.

FIG. 13 is a scanning electron microscopy image of the struvite crystals recovered from pretreated filtrate of sludge digestate in an air-lift crystallizer.

FIG. 14A is a SEM micrograph of xanthan gum.

FIG. 14B is a SEM micrograph of granules at 10 struvite:1 xanthan gum (XG1).

FIG. 14C is a SEM micrograph of guar gum.

FIG. 14D is a SEM micrograph of xanthan gum.

FIG. 14E is a SEM micrograph of corn starch.

FIG. 14F is a SEM micrograph of granules at 10 struvite:2 corn starch (CS2).

FIG. 15 is a graph containing FTIR transmittance spectra of struvite powder, organic binders (xanthan gum, guar gum, and corn starch), and struvite granules made with the organic binders.

### DETAILED DESCRIPTION OF THE INVENTION

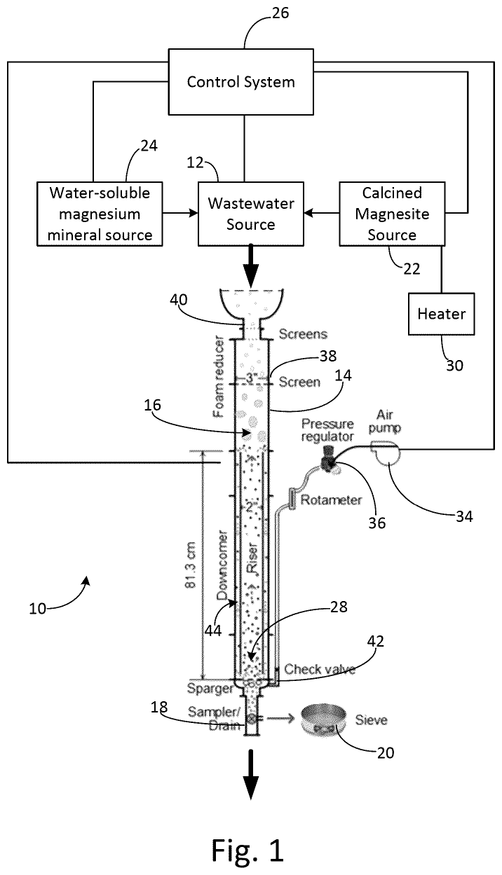

With reference to the figures in which like numerals represent like elements throughout the several views, FIG. 1 is a system 10 for recovering phosphate from a wastewater source 12 with a liquid container 14, shown here as a crystallizer, having an interior 16 thereof and an outlet 18 therefrom, and the interior 16 configured to receive wastewater in at least a semi-liquid form, and the wastewater contains at least phosphate. There is a filter 20 (shown here as a sieve) in outlet 18 of the liquid container 14 that will remove struvite that is produced in the manner more fully described below. There is a calcined magnesite source 22 and a water-soluble magnesium mineral source 24 to provide these to the wastewater from the wastewater source 12. The container 14 can be an air-lift crystallizer, a simple container, a liquid pass such as an elongate tube, or other like structure sufficient to execute the functionalities described herein.

There is a control system 26 configured to selectively add the calcined magnesite source 22 to wastewater in the interior 16 of the container 14, then selectively add the water-soluble magnesium mineral source 32 to the wastewater until a predetermined molar ratio of magnesium to phosphate thereby creating a mixture 28 of the calcined magnesite source 22, water-soluble magnesium mineral source 32, and wastewater. This process ultimately forms struvite in the mixture and the struvite is collectable in the filter 20 and can be used as an organic-certifiable natural fertilizer.

The crystallizer has a riser where compressed air push water-crystal fluid up through it. Rising air bubbles burst at the top of the riser while water-crystal fluid overflows and circulates through the downcomer between the riser and the crystallizer wall. Recirculation of water-crystal-air mixture facilitates crystal growth.

The system 10 can include a heating element 30 interacting with the milled magnesite for calcination. The system 10 can also further include water-soluble magnesium mineral source 32 such that the control system 26 further configured to selectively add the mineral salt to the mixture. Further, the calcined magnesite source 22 can also be ground to better cause dissolution in the mixture.

In an embodiment, the system 10 can also include an air source 34 connected to the interior 16 of the crystallizer 14 and operably connected to the control system 26 such that the control system 26 can create a predetermined velocity gradient based on the pressure and flow rate of the air supplied into the interior 16 of the crystallizer 14 by the air source 34. Here, the air source 34 is a pump and includes a pressure regulator 36 and rotameter to assist in maintaining pressure and flow rate into the interior 16.

Additionally, the crystallizer 14 can further contain one or more screens to control foaming. Here, the screen inside the crystallizer 38 has a small mesh number and the screen in the inlet 40 has a larger mesh number to help with reduce foaming. The calcined magnesite source 22, water-soluble magnesium mineral source 32, and wastewater source 12 can all be completely held inside the crystallizer 14 for batch operation, or can be continuously flowed through the crystallizer 14 and periodically remove struvite from the flowing mixture.

The present invention takes advantage of the phenomenon that when there is a significant increase in the ionic activity product of phosphate (PO₄³⁻), magnesium (Mg²⁺), and ammonium (NH₄⁺), and the wastewater becomes supersaturated with them, struvite crystallization will occur spontaneously. The recovery process of struvite typically follows two steps: crystal nucleation and crystal growth. Nucleation is crystal birth in which crystal embryos are formed and crystal growth is the development of crystals after crystal embryos have been born and it determines the final size of the crystals. The time it takes to form struvite nuclei is known as the induction time.

A main factor for struvite precipitation is the supersaturation of constituent ions in wastewater. Extended retention time of the crystal suspension under supersaturated conditions leads to an increase in struvite crystal size. Therefore, longer retention times in days are required to agglomerate the crystals to form fertilizer sizes of granules within the reactors.

In practical applications, slightly higher Mg²⁺ to PO₄³⁻ ratios have proved to be more efficient for phosphorus recovery as struvite. A Mg₂⁺ to PO₄³⁻ ratio of 1.2 proved to be optimum for struvite recovery from anaerobically digested swine wastewater, anaerobic sludge supernatant and urine.

The pH for effective recovery of phosphorus as struvite is generally in the range of 8.5-9.5. In this pH range, the solubility of struvite is lowest, nitrogen is present mainly in the form of NH₄⁺, and phosphate exists as HPO₄²⁻, making conditions suitable for struvite precipitation. Therefore, in most cases of struvite production, chemicals in the form of alkalis are added to increase pH for recovering struvite from wastewater.

The present invention can be used to recover struvite from different waste streams, such as anaerobic digester liquors, livestock and farm wastes, human urine, and landfill leachate, among others.

As the present invention teaches, careful control of solution pH, molar ratios of constituent ions, and residence time is essential in the design of struvite reactors to achieve a higher efficiency in struvite recovery.

the most used magnesium sources for struvite production are MgCl₂, MgSO₄, and Mg(OH)₂ both at laboratory scale studies and commercially available struvite recovery systems. MgSO₄ and MgCl₂ result in high salt concentrations and electrical conductivity in the resulting effluents whereas the lower solubility and thus longer reaction time renders Mg(OH)₂ less feasible for struvite production. The use of these salts is complemented by the utilization of alkali to control pH for the recovery process. These pure chemicals are expensive and increase the overall cost of production. Thus, alternative magnesium sources can improve the process economics and make struvite recovery profitable. Certain low-cost alternatives to chemical magnesium sources have been utilized including desalination bittern, seawater, thermally decomposed magnesite, acid-treated brucite, and milled serpentine, but their availability is limited to local regions, and their use may elevate the ionic strength of wastewater with the introduction of interfering ions.

With respect to the calcined magnesite source 22, Magnesite (MgCO₃) is a mineral present abundantly in nature. This mineral is the predominant source to produce magnesia (MgO) worldwide and as compared to chemical magnesium reagents, its cost is only about 1/10^{th}. Magnesite can be composed of as much as 98% of MgCO₃ making it a rich source of magnesium. However, it is sparingly soluble in aqueous solutions and its solubility in water is 0.01 g/L at 25° C. Therefore, to use it for struvite precipitation, it must be converted to reactive magnesium oxide by applying certain pretreatment such as acid extraction. However, these methods to increase its reactivity are chemical intensive.

Another way of increasing the reactivity of magnesite is calcining it after particle size reduction (Al-Mallahi et al., 2020). Calcination of magnesite mineral is carried out at high temperatures to decompose it to magnesium oxide (MgO) and carbon dioxide:

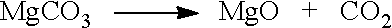

The effects of calcination temperature and duration on the dissolution of calcined magnesite in rare-earth processing wastewater, synthetic phosphate-depleted human urine, acidic electroplating wastewater, and liquid digestate, respectively, are known. Another benefit of the use of calcined magnesite is the production of hydroxyl ions upon dissolution in water, leading to an elevation in the pH of wastewater.

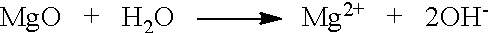 [SMILES: "MgO" ; "+" ; O ; [Mg+2] ; "+" ; "2OH-"]

Thus, calcined magnesite is versatile in providing both Mg²⁺ and OH ions to the wastewater simultaneously fulfilling the need to supplement magnesium and elevate pH for struvite recovery. The present invention has optimized the calcination process at light burnt temperature of 800° C. for 30 minutes to produce calcined magnesite for effective struvite formation.

Synthetic Epsom salt with the formula MgSO_{4·}7H₂O is a highly soluble salt and its solubility in water is 732 g/L at room temperature and pH of magnesium sulfate solution is slightly acidic. Owing to its high solubility, it has been successfully used as a magnesium source for struvite recovery. However, when synthetic Epsom salt is used to supplement magnesium, pH is increased using NaOH thus rendering the process expensive and struvite unsuitable for organic production. Conversely, Epsom salt derived from Epsomite minerals following good manufacturing practice, such as the OMRI-listed Magriculture® Epsom salt, can be directly applied to provide magnesium supplementation. Since its application is allowed in organic farming, struvite recovered from it can potentially be suitable for use in organic farming.

With reference again to FIG. 1, the reactor 14 is an air-lift crystallizer operated in a batch mode. The air-lift crystallizer was assembled with tri-clamp stainless steel spools and fittings. For each batch run, 3.2 L of hydrolyzed urine or filtrate of sludge digestate was added to the crystallizer from the top inlet 40. Compressed air introduced at the sparger 42 from the air source 34 lifts the mixture of wastewater, air, and fine crystals up through the riser (interior 16). The fluid mixture overflows at the top of the riser into the downcomer 44. The riser and downcomer 44 have similar cross-sectional areas. Air pressure at 162 kPa and flow rate at 1497 mL/min were maintained using a pressure regulator and a rotameter respectively, providing a G-value of 1568 1/s in the riser. 2.9±0.2 g of calcined magnesite CM3, 18.1±2.8 g of Epsom salt, or a combination of calcined magnesite and Epsom salt were added to each batch to reach an initial Mg²⁺:PO₄³⁻ molar ratio of 1.2.

After 1-6 h of batch operation, crystals were collected on the 38-μm sieve, washed with tap water, dried at room temperature, and weighed after complete drying. The air-dried crystals were further oven-dried at 45° C. for 24 h and characterized by SEM-EDS for surface morphology and elemental composition, XRD for determination of crystal phases, and FTIR for chemical composition. Each dried crystal sample (0.1 g) was digested in 0.01 L of 5 N H₂SO₄ at 150° C. for 60 min using a DRB2000 thermoreactor. The acid extracts were filtered through 0.22-μm membrane filters and examined for PO₄³⁻, Mg²⁺, and TAN concentrations.

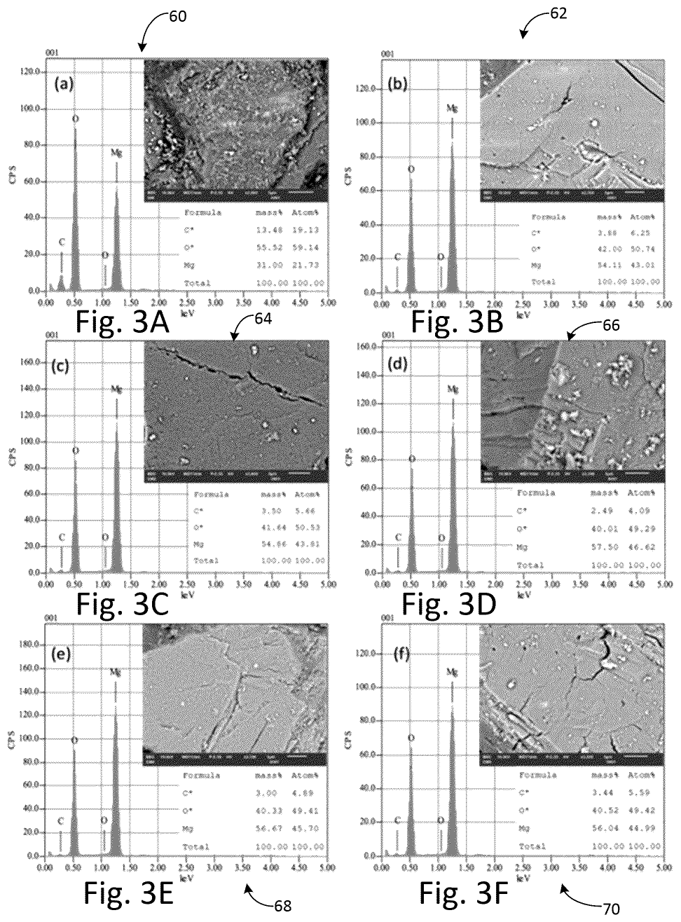

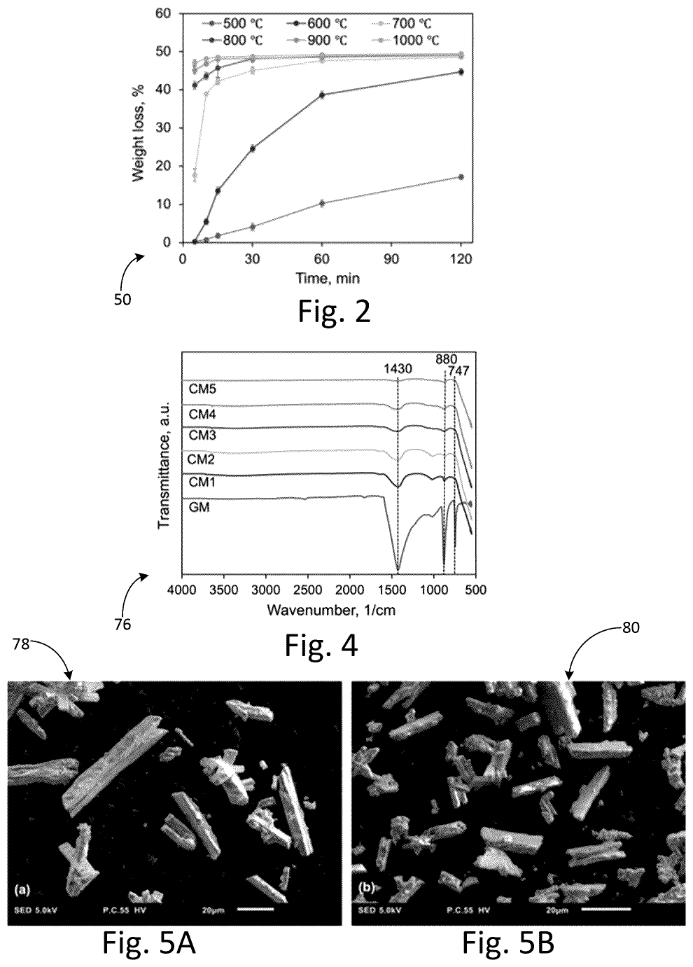

FIG. 2 is a graph 50 of the weight loss of magnesite in response to calcination duration and temperature. The weight loss of magnesite upon calcination reached up to 49.4% of the initial weight of magnesite, which was slightly lower than the theoretical weight loss (52.2%) when pure MgCO₃ is fully converted to MgO. As FIG. 2 shows, 500° C. was not high enough to satisfactorily calcine magnesite within 120 min. The magnesite calcined at 700° C. for 60 min (CM2), 800° C. for 30 min (CM3), 900° C. for 15 min (CM4), and 1000° C. for 10 min (CM5) achieved more than 49% weight loss with slightly less weight loss in magnesite calcined at 600° C. for 120 min (CM1).

FIG. 3A-3F presents SEM micrographs, EDS spectra, and elemental compositions of the ground and calcined magnesite samples. The SEM micrographs revealed rugged surfaces of ground magnesite while the surfaces of all the calcined magnesite samples were smooth with cracks. FIG. 3A is a SEM micrograph 60 and graph of EDS spectra of GM-ground magnesite. FIG. 3B is a SEM micrograph 62 and graph of EDS spectra of CM1-magnesite calcined at 600° C. for 120 min. FIG. 3C is a SEM micrograph 64 and graph of EDS spectra of CM2-magnesite calcined at 700° C. for 60 min. FIG. 3D is a SEM micrograph 66 and graph of EDS spectra of CM3-magnesite calcined at 800° C. for 30 min. FIG. 3E is a SEM micrograph 68 and graph of EDS spectra of CM4-magnesite calcined at 900° C. for 15 min. FIG. 3F is a SEM micrograph 70 and graph of EDS spectra CM5-magnesite calcined at 1000° C. for 10 min.

The EDS analysis showed that All the calcined magnesite samples had almost the same 0 percentages and a little lower Mg percentage than the theoretical atomic percentages of pure MgO (Mg=50 and 0=50). Among all the calcined magnesite samples, the magnesite calcined at 800° C. for 30 min (CM3) had the highest Mg percentage and lowest residual C percentage, indicating the optimum calcination conditions.

The FTIR transmittance bands of calcined and ground magnesite are presented in FIG. 4. The differences in the spectra of ground magnesite and the calcined magnesite samples indicated the conversion of magnesite to MgO. XRD diffractograms of ground magnesite and calcined magnesite revealed the presence of MgCO₃ and MgO respectively when compared to magnesite (RRUFF ID R050676.1) and periclase (AMCSD ID 0000501) diffractograms in the American Mineralogist Crystal Structure Database.

After hydrolysis, the urine pH values from 9.09 to 9.47 were close to the optimum pH range of 8.5-9.5 for efficient struvite recovery. HPO₄²⁻ is the predominant form among all soluble reactive phosphate species and struvite solubility decreases at this pH range making conditions conducive for struvite precipitation.

During the 3-6 h of crystallization in the jar tests with hydrolyzed urine, there were little changes in pH and the final pH 8.93-9.06 was suitable for struvite precipitation. Conductivity decreased over time as ions precipitated, suggesting the appropriate dosing of calcined magnesite. Supplementing urine with ground magnesite resulted in a very low phosphate removal efficiency (7.1%). Supplementing urine with Epsom salt attained immediate phosphate removal, reaching the highest phosphate removal efficiency of 89.8%. Among the urine samples supplemented with magnesite calcined under selected conditions, CM3 resulted in the greatest phosphate removal efficiency of 87.8%. Besides the greater solubility of MgO than MgCO₃, the cracks on the surfaces of the calcined magnesite could have promoted its reactive behavior in comparison to uncalcined magnesite. The specific surface area and pore volume of calcined magnesite decrease considerably from light-burnt (700-1000° C.) to hard-burnt (1000-1500° C.) calcination temperature and residence time, resulting in the greatest hydration activity of CM3 that was calcined at a lower temperature and shorter time.

Crystals of varying sizes were observed under SEM. FIG. 5A is an SEM image 78 of struvite crystals harvested from urine dosed with calcined magnesite (CM3). FIG. 5B is an SEM image 80 of struvite crystals harvested from urine dosed with Epsom salt. The crystals obtained from urine dosed with calcined magnesite (FIG. 5A) and Epsom salt (FIG. 5B) had the typical orthorhombic crystalline structure. Calcined magnesite also produced some X-shaped crystals which are also typical of struvite from urine.

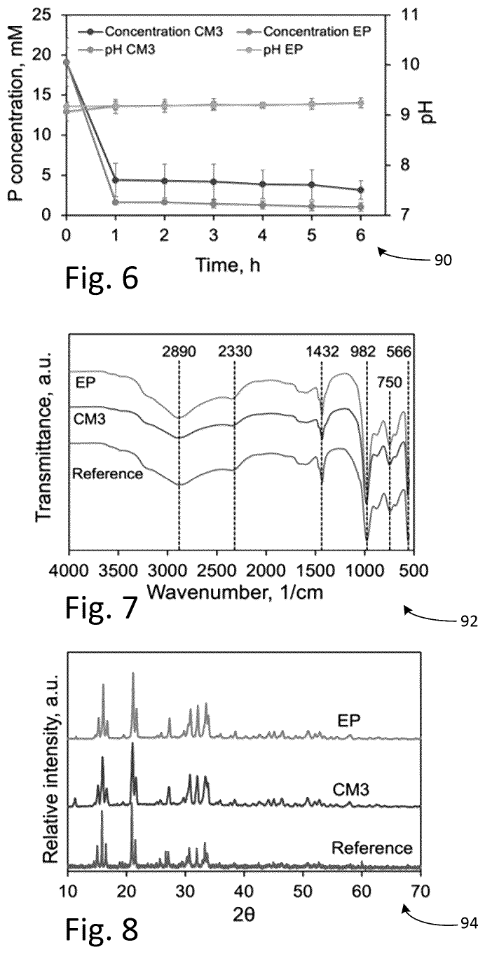

FIG. 6 is a graph 90 of the PO₄³⁻—P concentration, and pH of urine inside crystallizer over time after dosing calcined magnesite and Epsom salt. FIG. 6 shows that phosphate concentration in urine with the addition of calcined magnesite or Epsom salt decreased steeply in the first hour and slightly in the following hours, confirming the fast dissolution of calcined magnesite. In practical applications, one hour of hydraulic retention time is long enough to produce struvite crystals. The actual dosages of calcined magnesite and magnesium mineral product can be estimated stoichiometrically.

FIG. 7 is a graph 92 of the FTIR spectra of struvite crystals obtained from hydrolyzed urine. The transmittance peaks and bands in the FTIR spectra of the recovered crystals were identical to those of the reference struvite. XRD diffraction patterns of struvite samples obtained from urine shown in FIG. 8 were similar to those of reference struvite (RRUFF ID R050540.1) confirming their high purity.

FIG. 8 is a graph 94 of XRD diffractograms of struvite crystals obtained from hydrolyzed urine. Here, EP=struvite from Epsom salt, CM3=struvite from calcined magnesite.

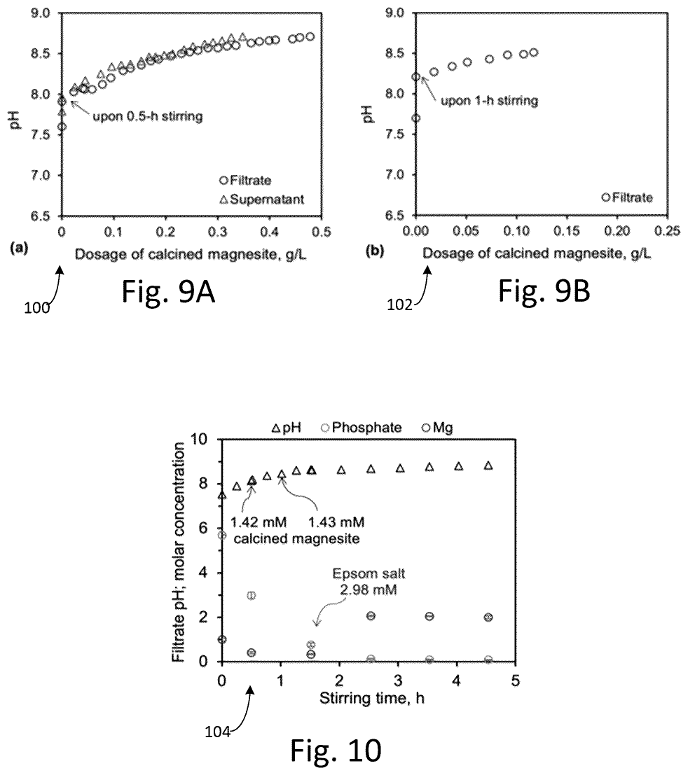

It should be noted that one advantage of air-lift crystallizers is that air sparging purges CO₂ out of high-alkalinity wastewater such as anaerobic digestate, thus raising pH. As shown in FIGS. 9A-9B, purging CO₂ by stirring in shallow beakers increased pH by 0.17-0.31 in sludge digestate in 0.5 h and 0.51 in co-digester influent in 1.0 h. FIG. 9A is a graph 100 of dosing curves of calcined magnesite to raise pH of filtrate and supernatant of sludge digestate. FIG. 9B is a graph 102 of dosing curves of calcined magnesite to raise pH of filtrate separated from co-digestion influent of sludge and chicken manure.

Based on a dosing curve, the amount of calcined magnesite needed to increase pH to above 8.5 for a specific wastewater stream could be estimated for scale-up struvite recovery. The dosage of calcined magnesite to reach pH 8.5 was 213-230 mg/L for sludge digestate, corresponding up to 5.29-5.71 mM of Mg²⁺ increases. Therefore, further magnesium supplementation at 1.13-1.55 mM to sludge digestate having an average PO₄³⁻ concentration of 5.70 mM is still required for effective struvite recovery at the minimum initial Mg²⁺:PO₄³⁻ ratio of 1.2. The dosage of Epsom salt can be estimated for further magnesium supplementation.

$$E S = ( 1.2 \times 40.3 \times {C}_{p} - CM ) \times 246.3 / 40.3$$

where ES=dosage of Epsom salt for further Mg supplementation after addition of calcined magnesite, g/L; CM=dosage of calcined magnesite to reach pH 8.5, g/L; and Cₚ=wastewater PO₄³⁻ concentration, M; 1.2=the minimum Mg²⁺:PO₄³⁻ molar ratio for struvite recovery; 40.3=molecular weight of MgO, g.

FIG. 10 is a graph 104 of variations of filtrate pH and concentrations of PO₄³⁻ and Mg²⁺ inside the crystallizer. Dots are averages of 4 replicates; error bars represent one standard deviation. As shown in FIG. 10, filtrate pH increased by 0.60 upon 0.5 h of air sparging, reached 8.5 at 1.0 h after adding calcined magnesite twice at a dosage of 2.85 mM or 115 mg/L, and remained between 8.6 and 8.9 after dosing 735 mg/L of Epsom salt at 1.5 h.

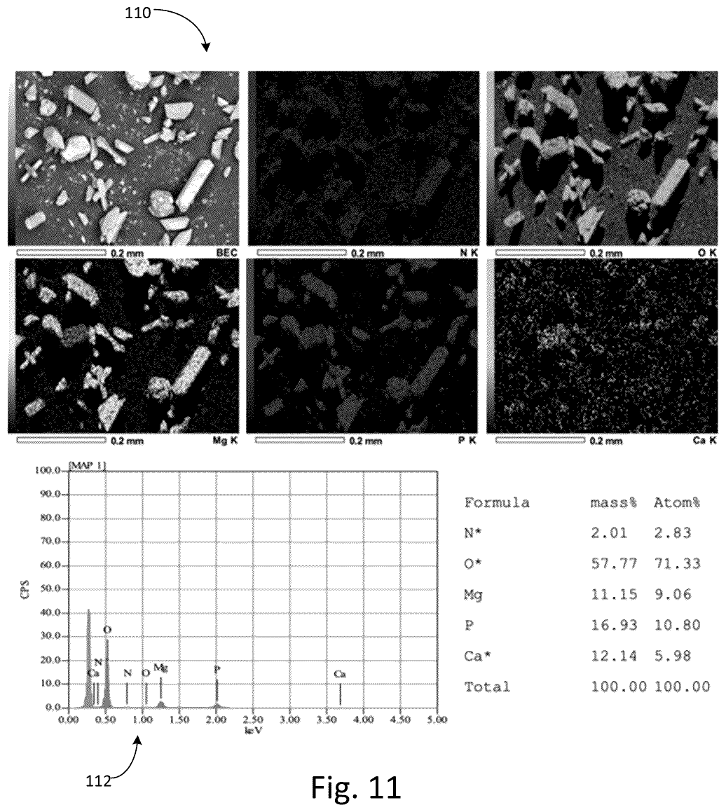

FIG. 11 is a series of SEM images 110 with a graph 112 illustrating the EDS concentration mapping of struvite crystals recovered from the filtrate of sludge digestate. The elemental mapping of harvested crystals using SEM-EDS also depicts the presence of calcium in the precipitates in FIG. 10 though no other metals were detected.

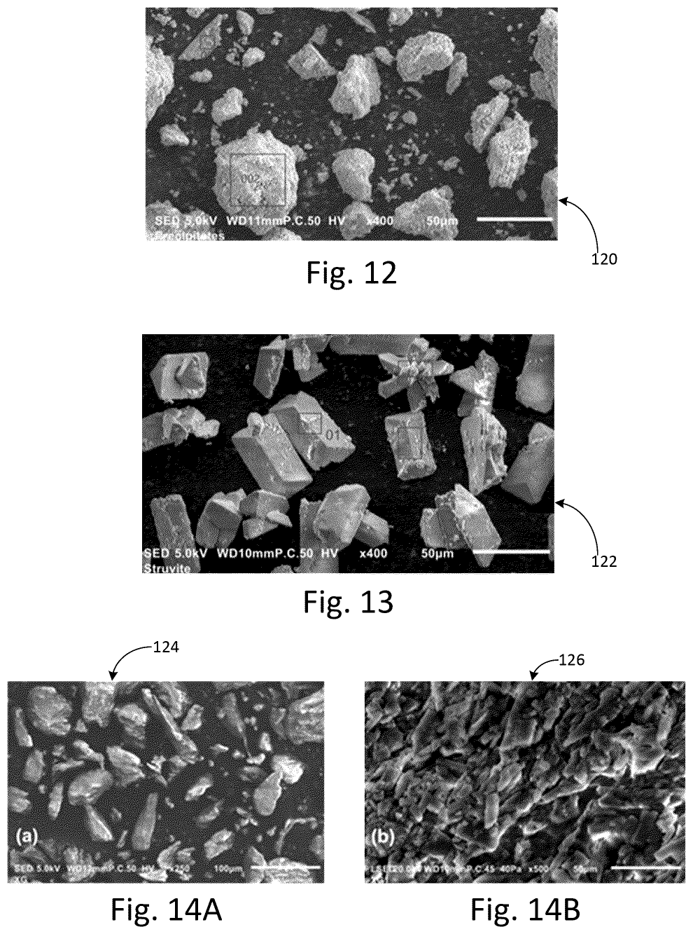

FIG. 12 is a scanning electron microscopy image 120 of the precipitates from air-stripping and settling pretreatment of the filtrate of sludge digestate. Two areas of the image at 400 times magnification were scanned by energy dispersive X-ray spectroscopy to determine the elemental composition of the precipitates. Table 1 shows the elemental composition of precipitates from air-stripping and settling pretreatment of the filtrate of sludge digestate:

TABLE 1
Energy dispersive X-ray spectroscopy

| | Area 01 | Area 02 |
|---|---|---|
| Element | atom % | atom % |
| O | 61.88 | 67.44 |
| Mg | n/a | 2.73 |
| P | 14.23 | 12.61 |
| Ca | 2.18 | 12.27 |
| Fe | 21.71 | 2.60 |

FIG. 13 is a scanning electron microscopy image 122 of the struvite crystals recovered from pretreated filtrate of sludge digestate in an air-lift crystallizer. Three areas of the image at 400 times magnification were scanned by energy dispersive X-ray spectroscopy to determine the elemental composition of the crystals. Table 2 shows elemental composition of struvite crystals recovered from pretreated filtrate of sludge digestate in an air-lift crystallizer.

TABLE 2
Energy dispersive X-ray spectroscopy

| | Area 01 | Area 02 | Area 03 |
|---|---|---|---|
| Element | atom % | atom % | atom % |
| O | 67.86 | 67.86 | 67.65 |
| Mg | 15.37 | 14.54 | 15.64 |
| P | 16.05 | 16.06 | 16.07 |
| Ca | 0.72 | 1.54 | 0.63 |

In an embodiment of pretreatment, 45 liters of filtrate of sludge digestate were held in a 60-liter barrel, compressed air was blown to a PVC manifold perforated with 3.2-mm orifices at the bottom of the barrel. One hour of air stripping and 0.5 hour of gravity settling removed calcium and iron precipitates as shown in FIG. 12, ensuring high-purity struvite crystals recovered from the pretreated filtrate as shown in FIG. 13.

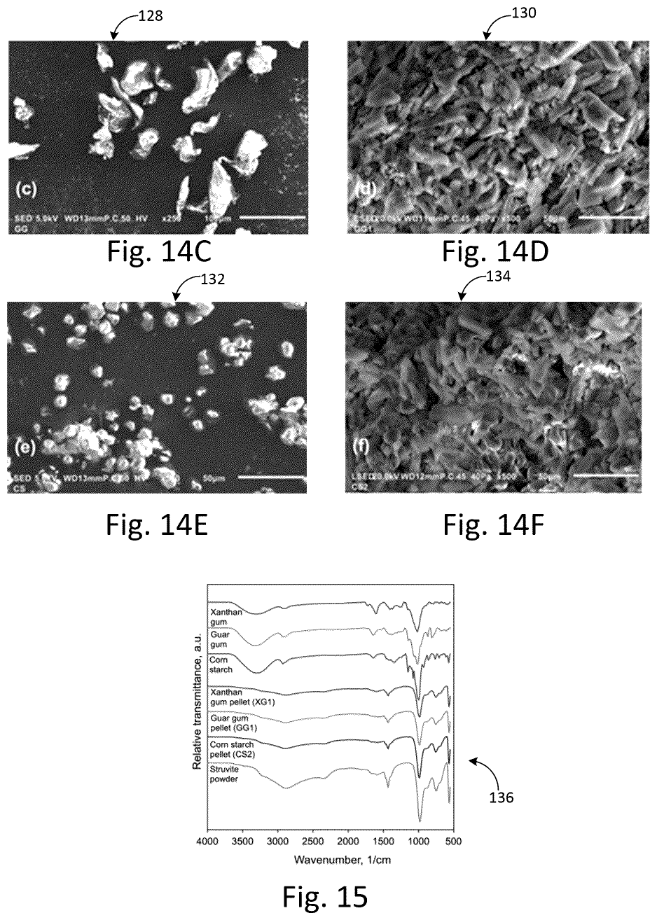

FIG. 14A is a SEM micrograph 124 of xanthan gum. FIG. 14B is a SEM micrograph 126 of granules at 10 struvite:1 xanthan gum (XG1). FIG. 14C is a SEM micrograph 128 of guar gum. FIG. 14D is a SEM micrograph 130 of xanthan gum, with granules at 10 struvite:1 guar gum (GG1). FIG. 14E is a SEM micrograph 132 of corn starch. FIG. 14F is a SEM micrograph 134 of granules at 10 struvite:2 corn starch (CS2).

Mineral products (calcined magnesite and Epsomite) were added to the pretreated filtrate in a 21.5-L air-lift crystallizer for struvite formation and crystallization. A velocity gradient of around 370 s⁻¹ at air pressure 83 kPa and air flow rate 10.7 mL/s in the riser could be strong enough to drive fluid recirculation. After only 60 minutes of batch operation, 90.2-95.6% of phosphate was removed from the pretreated filtrate. The purity of the settled struvite crystals was 93.6% on average. 87-93% by weight of the harvested crystals were smaller than 53 μm. When the crystals were pressed through a cutting plate with aperture size of 3.1 mm into granules at the ratio of 10 grams of crystals to 0.8 grams of guar gum to 5.4 grams of water, the granular natural fertilizer (FIGS. 14A-14F) had a fertilizer N-P-K grade of 5-26-0 plus 9% Mg as secondary plant nutrient. The granules had a loose low bulk density of 508 g/L, which is beneficial for application to soils as such granules may lower the bulk density of soil to improve water movement and air exchange. The granules had a size guide number of 336 and uniformity index of 52, being in the typical ranges of commercial fertilizers. The granules had abrasion resistance (2.2%) in the typical range of 0.4-30% degradation although the crushing strength was relatively low (0.44 kg).

In one embodiment, air-dried struvite crystals recovered from hydrolyzed human urine by dosing calcined magnesite and OMRI-listed Epsom salt were homogenized with a National Organic Program allowed organic binder and water at different ratios, pressed through 2.4-mm apertures, cut into granules, and air-dried. 67.1% of the crystals were smaller than 53 micrometers. Inside the screw press, the compression applied on the struvite crystals-binder-water mixture promotes the interlocking of particles.

FIG. 15 is a graph 136 containing FTIR transmittance spectra of struvite powder, organic binders (xanthan gum, guar gum, and corn starch), and struvite granules made with the organic binders. Here, XG1=10 g struvite crystals:1 g xanthan gum; GG1=10 g crystals:1 g guar gum; CS2=10 g crystals:2 g corn starch. As shown in FIG. 15, both the struvite crystals and granules exhibited typical transmittance peaks associated with struvite. The granules made with different binders at different dosages had similar surface functional groups (FIG. 15) as well as similar pH (8.5-8.9), salt index (2.6-3.5), and loose bulk density (0.33-0.38 g/cm³), though granule crushing strength varied substantially (0.44-1.40 kg) with binder type and dosage for granulation. Guar gum at the struvite crystal to binder weight ratio of 10:1 rendered granules with the highest crushing strength (1.28 kg), followed by xanthan gum (0.92 kg). The struvite granules had alkaline pH values and low salt indexes, suggesting slow release of nutrients and indicating the minimal risk of inducing soil salinity.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the invention for various embodiments with various modifications as are suited to the particular use contemplated.

What is claimed is:

1. A system for recovering phosphate from wastewater, comprising:
a liquid container having an interior thereof and an outlet therefrom, the interior configured to receive wastewater in at least a semi-liquid form, the wastewater containing at least phosphate;
a calcined magnesite source;
a water-soluble magnesium mineral source;
a filter in the outlet of the liquid container; and
a control system configured to:
selectively add the calcined magnesite source to wastewater in the interior of the container;
selectively add the water-soluble magnesium mineral source to the wastewater until a predetermined molar ratio of magnesium to phosphate thereby creating a mixture of the calcined magnesite source, water-soluble magnesium mineral source, and wastewater; and
form struvite in the mixture, the struvite collectable in the filter in the outlet of the liquid container.

2. The system of claim 1, further including a heating element heating the calcined magnesite source.

3. The system of claim 1, wherein the container is a crystallizer.

4. The system of claim 1, wherein the calcined magnesite source is ground.

5. The system of claim 3, further including an air source connected to the interior of the container and operably connected to the control system, and wherein the control system further selectively controlling a predetermined velocity gradient based on pressure and flow rate of the compressed air supplied into the interior of the crystallizer.

6. The system of claim 1, wherein the control system further selectively adds the water-soluble magnesium source to the wastewater until at least a molar ratio for magnesium to phosphate being 2:1.

7. The system of claim 1, wherein the container further contains one or more screens to control foaming.

8. The system of claim 1, wherein the filter is further configured to continuously remove struvite from the mixture.

9. A method for recovering phosphate from wastewater, comprising:
streaming wastewater through a liquid container having an interior thereof and an outlet therefrom, the wastewater in at least a semi-liquid form and containing at least phosphate;
adding a calcined magnesite source to the wastewater;
adding a water-soluble magnesium source to the wastewater until a predetermined molar ratio of magnesium to phosphate thereby creating a mixture of the calcined magnesite source, water-soluble magnesium mineral source;
forming struvite in the mixture; and
filtering the struvite from the mixture.

10. The method of claim 9, further include a calcined magnesite source.

11. The method of claim 9, wherein streaming wastewater through a liquid container is streaming wastewater through a crystallizer.

12. The method of claim 9, further comprising mixing the calcined magnesite source into water prior to adding the calcined magnesite source to the wastewater.

13. The method of claim 9, further selectively supplying air to the interior of the container to create a predetermined pressure inside the interior.

14. The method of claim 9, wherein adding a water-soluble magnesium mineral source to the wastewater is adding the water-soluble magnesium until there is at least a molar ratio for magnesium to phosphate being 1.2:1.

15. The method of claim 9, further mixing the mixture prior to filtering the struvite from the mixture.

16. The method of claim 9, further continuously flowing the calcined magnesite source, water-soluble magnesium mineral source, and wastewater through the container as a mixture.

17. The method of claim 16, further continuously removing struvite from the flowing mixture.

18. A system for forming and removing struvite in a wastewater stream, comprising:
a liquid passage having an interior thereof an outlet therefrom, the interior configured to receive a stream of wastewater in at least a semi-liquid form, the wastewater containing at least phosphate;
a calcined magnesite source;
a water-soluble magnesium mineral source;
a filter in the outlet of the liquid passage; and
a control system configured to:
selectively add the calcined magnesite source to the wastewater stream in the interior of the liquid passage;
selectively add the water-soluble magnesium mineral source to the wastewater stream until a predetermined molar ratio of magnesium to phosphate thereby creating a mixture stream of the calcined magnesite source, water-soluble magnesium mineral source, and wastewater; and
form struvite in the mixture stream, and
wherein the formed struvite is filtered from the mixture stream by the outlet of the liquid container.

19. The system of claim 18, further including a heating element heating milled magnesite sources.

20. The system of claim 18, further including an air source connected to the interior of the liquid passage and operably connected to the control system, and wherein the control system further selectively controlling a predetermined pressure inside the liquid passage from air supplied into the interior of the liquid passage by the air source.
